(19) United States
(12) Patent Application Publication
(10) Pub. No.: US 2005/0268971 A1
(43) Pub. Date: Dec. 8, 2005

(54) Tanker overfill protection system

(75) Inventors: Earl W. Nasalroad, Yale, OK (US); Rickey D. Miller, Stroud, OK (US)

Correspondence Address: PEPPER HAMILTON LLP, ONE MELLON CENTER, 50TH FLOOR, 500 GRANT STREET, PITTSBURGH, PA, 15219, US

(73) Assignee: Sunoco Partners Marketing &Terminals L.P.

(21) Appl. No.: 11/127,406

(22) Filed: May 12, 2005

Related U.S. Application Data
(60) Provisional application No. 60/572,406, filed on May 19, 2004.

(51) Int. Cl. F16K 21/04

(52) U.S. Cl. 137/565.13

(57) ABSTRACT

An overfill protection system for a tank-equipped vehicle includes a load pump that is fluidly connected to a source pipe and a delivery pipe. A bypass system is also connected to the source pipe and fluidly connected to the source pipe and delivery pipe. The bypass system includes a pressure sensitive device that directs fluid through the bypass system instead of the tank if pressure in the tank exceeds an undesirable amount.

### RELATED APPLICATIONS AND CLAIM OF PRIORITY

This application claims priority to U.S. provisional patent application No. 60/572,406, filed May 19, 2004, which is incorporated herein by reference in its entirety.

### TECHNICAL FIELD

The embodiments described herein relate to spill prevention systems for tanker trucks. More specifically, these embodiments relate to a system that prevents a storage tank from being overfilled during the loading procedure.

### BACKGROUND

Tanker trucks are used to transport a wide variety of liquids, such as crude oil, gasoline, kerosene, waste oil and other liquids. Because of the hazardous nature of many liquids that are transported in such trucks, it is desirable to prevent overfill of the tank. An overfill event can result in a spill of oil, gasoline or other hazardous material. Hazardous material spills can be very expensive to clean up, and a spill may harm the environment if it occurs in a significant quantity and/or in an environmentally-sensitive location.

Most tanker truck liquid storage vessels include a vent pipe that prevents excessive pressure buildup inside the tank during the loading procedure. The prevention of pressure build-up is especially important with expandable liquids, such as gasoline and other hydrocarbon liquids. However, the vent can allow liquid to escape if the tank is overfilled.

Several devices have been installed on tanker trucks in the prior art in order to attempt to solve the overfill problem. For examples, trucks have been equipped with sight gauges that the driver must watch in order to visually identify when the tank is approaching its maximum capacity. However, sight gauges are susceptible to human error. In particular, if a driver walks away from the truck while the loading process is proceeding, the sight gauge will not be monitored, and the tank may overfill.

Some prior systems have also used digital gauges. A digital gauge, when operative, may provide the driver with a numeric reading of the percentage of fill or the number of gallons that are in the tank. Optionally, an alarm may sound, or the pump that loads the liquid into the tank may automatically shut off if the digital gauge obtains a reading that exceeds a predetermined level. However, electronic systems are prone to failure, especially when installed on trucks that must drive on the bumpy roads, gravel areas and/or other rough terrain that is common in oil well fields, tank yards and other loading areas. In addition, even if a digital gauge does not completely fail, it may provide incorrect readings due to the jostling that it endures during transportation. When the readings are inaccurate, frustrated drivers may physically bypass or cut the wires associated with the gauge, thus rendering the system useless.

Accordingly, we have found it desirable to provide an improved portable tanker overfill prevention system.

### SUMMARY

In an embodiment, a tank overfill protection system may be used with a vehicle such as a truck that includes a pump and storage vessel. The load pump is fluidly connected with the storage vessel so that the pump receives liquid from a source via a first pipe and delivers the liquid to the vessel via a second pipe. The system includes pump bypass piping, where the bypass piping includes a pressure sensitive device and optional check valve that are fluidly connected in series with each other and in parallel with the load pump. The system also includes an overfill float in the load vessel. When the vessel is filled to a predetermined level, the float engages with a discharge vent and prevents pressure discharge through the vent. When the pressure in the vessel builds to a level that is sufficient to rupture the rupture disk, fluid from the discharge end of the load pump is directed through the bypass system instead of to the storage vessel. The fluid that is in the bypass system will then circulate through the bypass system and the pump until the pump is shut off. Thus, additional fluid will not be obtained from the source or directed into the vessel until the tank pressure is relieved.

### BRIEF DESCRIPTION OF THE DRAWINGS

FIG. 1 is a piping and instrumentation diagram showing an embodiment of a tank truck storage vessel, load pump and overfill protection system.

FIG. 2 illustrates an exemplary overfill float and storage vessel pressure relief vent, viewed from the inside of the storage vessel.

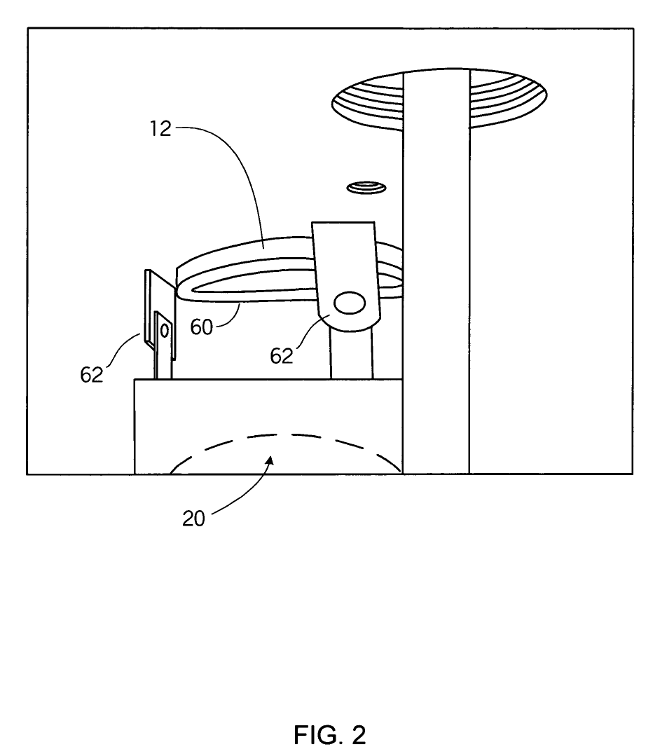

FIG. 3 illustrates a side view (cut-away) and top view of an exemplary overfill float.

FIG. 4 illustrates an exemplary embodiment of piping installed to provide a bypass system around a pump on a tanker truck.

### DETAILED DESCRIPTION

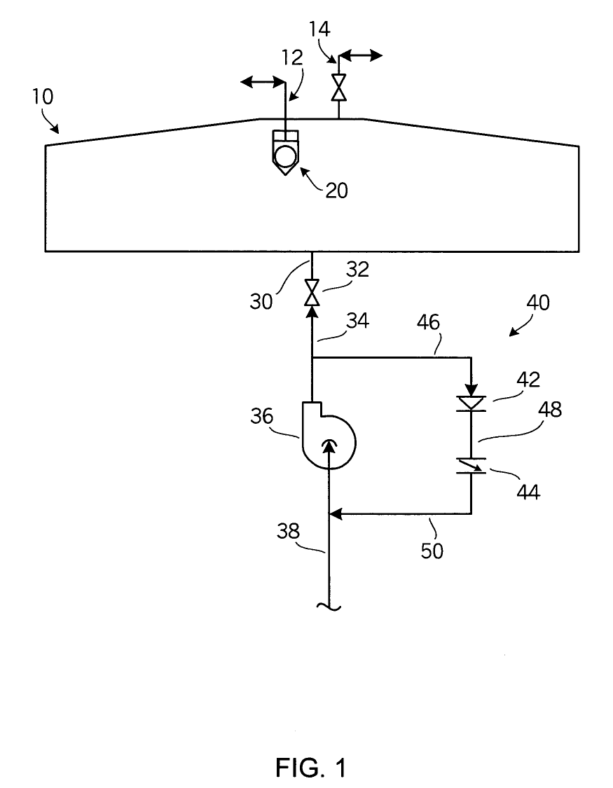

An embodiment of a tanker truck overfill protection system is illustrated in FIG. 1. Referring to FIG. 1, an optional relief valve 14 and an overfill float 20 are positioned inside the storage vessel 10. The storage vessel 10 has a vent 12 and is mounted on a truck and may be used to carry liquids, such as crude oil, gasoline, kerosene, waste oil, milk or other liquids. The vessel 10 may be loaded via an opening 30 that is typically, but not necessarily, connected to or integral with a valve 32 that prevents liquids from escaping the vessel under normal operation. Liquid may be directed into the vessel via a delivery pipe 34. Liquid may be pumped through the delivery pipe 34 by a pump 36 with an intake that receives the liquid via the source pipe 38 from a source, such as an oil well field tank, a gasoline product tank yard or another source. The pump and piping are fluidly connected via sealed connections, welded connections or other connections know to those skilled in the art.

Overfill protection may be provided by a combination of an overfill float 20 and a bypass system 40. The bypass system 40 includes a pressure-sensitive device 42, such as a rupture disk, or spring-loaded pressure sensitive check valve, and an optional check valve 44. The pressure-sensitive device 42 and check valve 44 may be fluidly connected in series with each other, optionally via one or more interconnecting pipes. Together, pressure sensitive device 42 and check valve 44 are fluidly connected in parallel with the pump 36, also optionally via one or more interconnecting pipes. Interconnecting pipes such as 46 and 50 may be connected to the delivery pipe 34, the source pipe 38 and/or the pump 36 itself. When any pipes are interconnected, the connection may be via a “tee”, via a weld, or via any other suitable connection item. In the embodiment illustrated in FIG. 1, the pipes are four-inch aluminum pipes, although other sizes and other types of pipes, such as other metal or plastic pipes, may be used.

The size and type of load pump and its corresponding driver (such as an electric or fuel-powered motor) may include any commercially available pump and motor that may be mounted on a vehicle, and which are together suitable to retrieve the fluid from the source and deliver it to the vessel. For example, a four-inch diameter pump made of cast steel may be suitable for loading and unloading oil. Other sizes are possible. The pump may be driven by any suitable motor, such as a hydraulic or electric motor.

During a fill operation, the vessel 10 is filled to a predetermined level, the float 20 engages with the discharge vent 12 and prevents pressure discharge through the vent 12. The discharge vent 12 or overfill float 20, and preferably both, may be fitted with seals such as rubber “o” rings to provide a substantially airtight seal. As the fill operation continues, the liquid level in the vessel may eventually rise to the level where the float 20 will engage the vent 14, thus preventing air discharge through the vent 12. Pressure in the vessel will then build, and it may eventually reach a level that is sufficient to activate the pressure-sensing device 42.

When the pressure-sensing device is activated or opened, fluid flows through pipe 46 into the bypass system 40. The pressure-sensitive device must be capable of activating or opening when the pressure in the system reaches a predetermined level that is somewhere below the design pressure of the storage vessel 10. Because of the pressure that has built up in the vessel 10, fluid discharged from the pump 26 will flow to bypass system 40 instead of to the storage vessel 10. The fluid that is in the bypass system 40 will then circulate through the bypass system 40 and the pump 10 until the pump 10 is shut off. Thus, additional fluid will not be obtained from the source or directed into the vessel until the tank pressure is relieved. Check valve 44, which may be an ANSI 150 series, spring-loaded, ⅜-inch, wafer check valve or other suitable device, prevents the flow in the bypass system 40 from flowing in a direction that is opposite the intended direction. Check valve 44 is not required, but it may be used in various embodiments.

In embodiments where the pressure sensing device 42 is a rupture disk, the disk may rupture, thus allowing fluid to flow through pipe 46 into the bypass system 40. When the pressure-sensitive device is a rupture disk, it may be made of graphite, aluminum, steel or any other suitable material. Rupture disks are commonly available from a variety of manufacturers, and they typically include a membrane and supporting ring. The membrane is made of an impermeable or substantially impermeable material, such as graphite that is impregnated with phenolic resin. Other materials are possible. The membrane will rupture when exposed to a pressure that exceeds a predetermined design tolerance. The supporting ring surrounds and holds the membrane, and it may have a dimension that allows it to fit between standard pipe flanges. The rupture disk may be replaced after a rupture event occurs.

In another embodiment, the pressure-sensitive device may include a pressure-sensitive check valve. Such a valve will open when pressure exceeds a set level, and close when pressure does not exceed the level. Suitable valves may include spring-loaded, pin and plunger, thermal relief or other valves. Examples of suitable spring-loaded check valves include those available from Check-All Valve Manufacturing Company, such as four-inch diameter stainless steel valves. Other sizes, materials and manufactures are also suitable.

Many tank truck storage vessels are built to a design pressure tolerance of 45 psi. Thus, in such cases a pressure-sensitive device activation level that is less than 45 psi is desirable. In an embodiment, referring again to FIG. 1, the pressure-sensing device activates at a pressure that is less than the design pressure of a pressure relief valve 14 or other device on the vessel 10. This allows the pressure relief valve 14 to serve as a backup for the pressure-sensitive device 42 and bypass system 40 in the event of a bypass system failure, such as a clog in the bypass system pipes. Pressure relief valve 14 is optional, and pressure-sensitive device 42 could be set to activate at a level corresponding to a sensitivity or tolerance of another device, or even based on the tolerance of the tank itself. Many tank truck storage vessels have a pressure relief valve that activates at 28-32 psi. Accordingly, we have found that a pressure-sensitive device activation level of 25 psi may be desirable. Of course, other activation levels may be used, depending on the design of the vessel and its pressure relief system, and all such activation levels are within the scope of the invention.

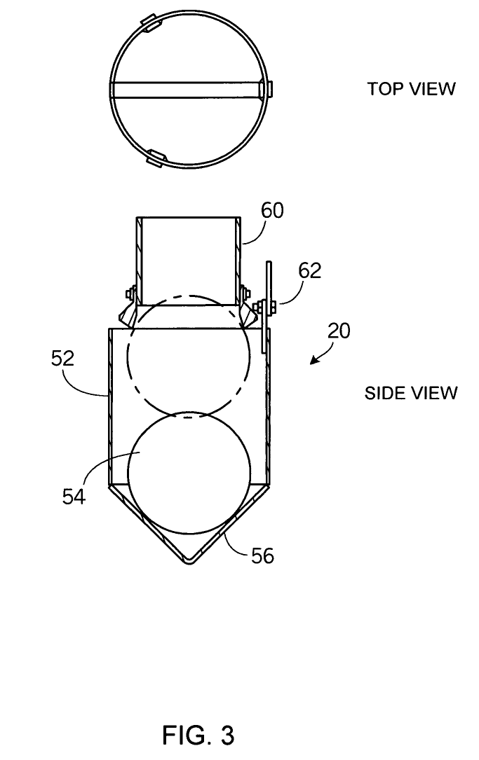

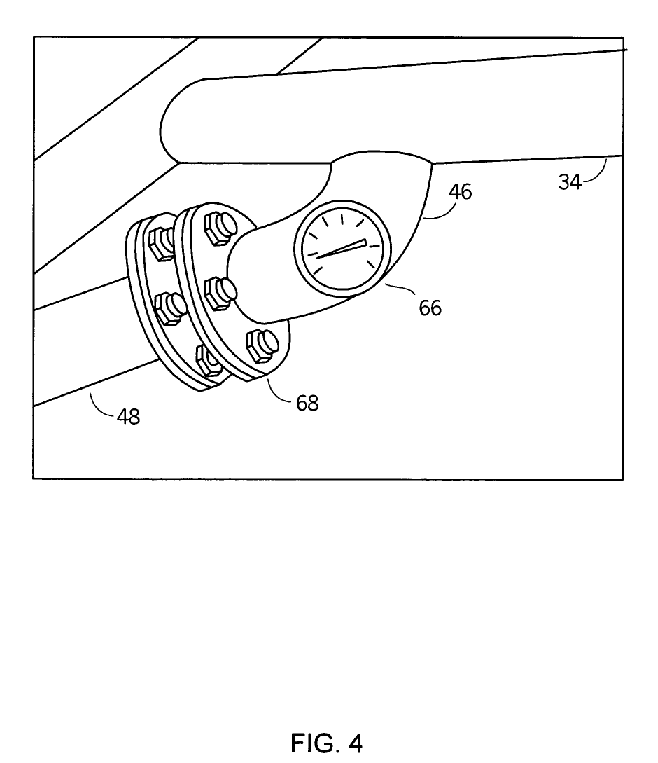

FIG. 3 illustrates an exemplary design for an overfill float 20 as it may engage with a tank vent 12, viewed from the inside of a tanker. Referring to the cut-away view of FIG. 4, the overfill float 20 may be made of exterior walls 52 and one or more ball floats 54. The exterior walls 52 may be, for example, a cylindrical shape to form a canister. Other shapes, such as square, rectangular, hexagonal or other shapes, may be suitable. The ball float 54 is housed inside of the walls 52. The exterior walls are fixed to the tank or the tank vent by one or more supports 62. While FIGS. 3 and 4 illustrate a bolt attachment that fixes the canister to the tank vent, one skilled in the art will recognize that other support configurations are possible. A lower area of the exterior walls 52 may be partially or substantially open to receive liquid as the liquid level rises inside of the tank. The ball float 54 may be kept inside of the canister by a support 56 such as a strap, a bar, or a funnel. The support is sufficiently sized to keep the ball inside of the canister while allowing liquid to enter the canister as the liquid level rises in the tank. The walls 52, ball 54 and support 56 may be made of carbon steel, stainless steel, or another suitable material.

When the liquid level rises in the tank, the ball float 56 will rise (as shown by the broken-line ball in FIG. 4) and eventually engage a seal 60 that is attached to the tank vent 12. The walls 52 of the canister may guide the ball float 56 and direct the ball float 56 toward the seal 60. The seal 60 may be made of any suitable sealing material, such as a commercially available rubber sealing ring. When the ball float 56 engages the seal 60, the vent 12 will be blocked and air pressure inside the tank will rise. As the pressure rises, referring again to FIG. 1, pressure in the bypass piping system will also rise.

The embodiment shown in FIG. 3 is an example of a suitable shape and size for a commercially available ball float and tank vent. In one embodiment, the tank vent may have an interior circumference of approximately 6⅔ inches. The canister may have both a circumference and a height of approximately eight to approximately ten inches. Other materials, designs, shapes and sizes are possible while remaining within the scope of the invention.

FIG. 5 illustrates an exemplary embodiment of bypass piping 46 and 48, with a flange 68 to accept a pressure sensitive device 42 as it may be installed on a truck. In this embodiment, an optional pressure gauge 66 is also installed in the system.

Some of the preferred embodiments have been set forth in this disclosure for the purpose of illustration. However, the foregoing description should not be deemed to be a limitation on the scope of the invention. Accordingly, various modifications, adaptations, and alternatives may occur to one skilled in the art without departing from the spirit and scope of the claimed inventive concept.

1. A tank overfill protection system, comprising:
a load pump having an intake and a discharge;
a source pipe fluidly connected to the pump intake;
a delivery pipe fluidly connected to the pump discharge; and
a bypass system comprising bypass piping and a pressure sensitive device;
wherein the bypass piping is fluidly connected to the delivery pipe and the source pipe so that the pressure sensitive device is fluidly parallel with the pump.

2. The system of claim 1, wherein the load pump is connected to receive a liquid from a source via the source pipe, and to a liquid storage vessel via the delivery pipe.

3. The system of claim 2, wherein the load pump is connected to deliver fluid from the source to the delivery pipe.

4. The system of claim 2, wherein fluid expelled from the pump discharge is passed through the bypass system instead of to the storage vessel when the pressure sensitive device is activated.

5. The system of claim 4, wherein, when the pressure sensitive device is activated, the fluid circulates through the bypass system and the load pump until the load pump is deactivated.

6. The system of claim 1, wherein the bypass system further comprises a check valve connected in series with the pressure sensitive device to ensure that fluid may circulate in the bypass system in only one intended direction.

7. The system of claim 2, wherein fluid is directed from the load pump to the storage vessel when pressure in the vessel is below a predetermined level and fluid is directed from the load pump to the bypass system when pressure in the vessel is above a predetermined level.

8. The system of claim 2, wherein the storage vessel is portable and can be mounted onto a vehicle.

9. The system of claim 2, wherein the storage vessel further comprises a relief valve and an overfill float.

10. The system of claim 9, wherein the storage vessel further comprises a discharge vent.

11. The system of claim 9, wherein the overfill float and the relief valve are positioned inside the storage vessel.

12. The system of claim 10, wherein the overfill float engages with the discharge vent of the storage vessel to prevent pressure discharge through the vent when the vessel is filled with fluid to a predetermined level.

13. The system of claim 2, wherein the pressure sensitive device opens when a pressure in the storage vessel reaches a sufficient level to open said pressure sensitive device during the filling operation.

14. A tank overfill protection system, comprising:
a load pump; and
a bypass system fluidly connected in parallel with the load pump, the bypass system comprising a pressure sensitive device connected in series with a check valve via interconnecting pipes.

15. The system of claim 14, wherein the load pump is connected to a source via a source pipe, and to a mobile storage vessel via a delivery pipe.

16. The system in claim 14, wherein the fluid from the discharge end of the load pump is passed through the bypass system, instead of to the storage vessel, when the pressure sensitive device is activated.

17. The system in claim 14, wherein the check valve allows fluid to circulate in the bypass system in only one intended direction.

18. A bypass system, comprising:
a pressure sensitive device;
a pipe fluidly connecting the device to a discharge of the pump;
a pipe fluidly connecting the device to an intake of the pump;
wherein the system is configured to deliver fluid from the discharge to the intake if pressure at the discharge exceeds a predetermined level; and
wherein the system is configured to deliver the fluid from the discharge to a mobile storage vessel if the pressure does not exceed a predetermined level.

19. The system in claim 18, further comprising a check valve that prevents fluid from flowing from the intake to the discharge through the bypass system.

20. The system in claim 18, wherein the predetermined level is below a level of pressure that the storage vessel is designed to hold.
